(19) United States
(12) Patent Application Publication
(10) Pub. No.: US 2002/0156977 A1
(43) Pub. Date: Oct. 24, 2002

(54) Virtual caching of regenerable data

(76) Inventors: John E. Derrick, Round Rock, TX (US); Robert G. McDonald, Austin, TX (US)

Correspondence Address: Lawrence J. Merkel, Conley, Rose, & Tayon, P.C., P.O. Box 398, Austin, TX, 78767, US

(21) Appl. No.: 09/840,723

(22) Filed: Apr. 23, 2001

(51) Int. Cl. G06F 13/00; G06F 12/00

(52) U.S. Cl. 711/118; 711/203

(57) ABSTRACT

A system includes a virtual caching mechanism. A virtual cache is mapped to an address range separate from the main memory address range within a cacheable address space of the system. Regenerable data may be generated from source data and may be allocated space in the virtual cache. The CPU may fetch the data from the virtual cache (and the data may be supplied by a control circuit monitoring the CPU interface for addresses within the address range corresponding to the virtual cache). The data may be cached in a CPU cache, but may not be stored in the main memory. Thus, the CPU may have access to the regenerable data via the CPU cache, but main memory locations may not be required to store the regenerable data. If the regenerable data is replaced in the CPU cache and subsequently requested by the CPU, the regenerable data may be regenerated and supplied to the CPU.

### BACKGROUND OF THE INVENTION

1. Field of the Invention

This invention is related to caching of data in a system.

2. Description of the Related Art

Many types of systems include small amounts of main memory (memory accessible directly by a central processing unit (CPU) in the system via explicit load/store instructions or implicit load/store operations, in instruction sets having memory operands for non-load/store instructions). For example, set top boxes, personal digital assistants, and other hand-held computing devices generally have a limited amount of memory when compared to desktop personal computer systems. Even more limited memory is generally included in systems such as smart cards, which may have as little as 4 kilobytes (4 k or 4 kb) of main memory. Smart cards are cards which resemble credit cards but which include computing circuitry for performing various computations, e.g. carrying a prepaid balance in the card and adjusting the balance as the money is used, providing identification of a user (such as transmitting a pass code to a door lock, computer, etc.; or storing and transmitting user information in E-commerce situations), etc.

Since these types of systems do not include large amounts of memory, efficient memory use is imperative. If the memory is not used efficiently, performance of the overall system may suffer. As mentioned above, the CPU typically accesses most information from the main memory, and so high performance in the system is only realized if data needed by the system is in the main memory at the time the CPU needs to operate on the data. The performance loss may be felt in a variety of ways, e.g. in slower response to user interaction or in a limitation on the features and functionality that the system can support.

### SUMMARY OF THE INVENTION

A system is described which includes a virtual caching mechanism. A virtual cache is mapped to an address range separate from the main memory address range within a cacheable address space of the system. Regenerable data may be generated from source data and may be allocated space in the virtual cache. The CPU may fetch the data from the virtual cache (and the data may be supplied by a control circuit monitoring the CPU interface for addresses within the address range corresponding to the virtual cache). The data may be cached in a CPU cache, but may not be stored in the main memory. Thus, the CPU may have access to the regenerable data via the CPU cache, but main memory locations may not be required to store the regenerable data. Thus, main memory usage may be more efficient. If the regenerable data is replaced in the CPU cache and subsequently requested by the CPU, the regenerable data may be regenerated and supplied to the CPU.

In one embodiment, the regenerable data may be one or more translated code sequences corresponding to source code sequences coded in an instruction set other than the instruction set implemented by the CPU. In another embodiment, the generable data may be compressed data (which may be code for execution by the CPU or operand data to be operated on by the CPU). Any type of regenerable data may be supported in various embodiments.

Broadly speaking, an apparatus is contemplated, comprising a buffer configured to store at least one block of data and a control circuit coupled thereto. The control circuit is further coupled to receive a first address transmitted by a central processing unit (CPU), wherein the first address identifies a corresponding block of data. The control circuit is configured to detect whether or not the first address is in a first address range. Additionally, if the corresponding block of data is stored in the buffer, the control circuit is configured to provide the corresponding block of data to the CPU. If the corresponding block if data is not stored in the buffer and the first address is in the first address range, the control circuit is configured to cause a generation of the corresponding block of data from a source data. Additionally, a carrier medium carrying a database representing the apparatus is contemplated.

Furthermore, a system is contemplated. The system comprises a central processing unit (CPU), a cache configured to store blocks of data for use by the CPU, and a circuit coupled to receive a first address transmitted by the CPU. The first address identifies a corresponding block of data generated from a source data if the first address is within a first address range detected by the circuit. The circuit is configured to generate the corresponding block of data from the source data if the corresponding block of data is not available. The cache is coupled to receive the corresponding block of data from the circuit and is configured to store the corresponding block of data.

Moreover, a method is contemplated. A first address is detected within a first address range. The first address identifies a corresponding block of data which is generated from a source data. A generation of the corresponding block of data is caused if the corresponding block of data is not available. The corresponding block of data is cached in a cache which stores blocks of data for use by a central processing unit (CPU). The corresponding block of data is not also stored in a main memory system.

### BRIEF DESCRIPTION OF THE DRAWINGS

The following detailed description makes reference to the accompanying drawings, which are now briefly described.

FIG. 1 is a block diagram of one embodiment of a system including a code translator, a CPU, and a main memory.

FIG. 2 is a block diagram of one embodiment of an address space, a CPU cache, and a code buffer.

FIG. 3 is a flowchart illustrating operation of one embodiment of a control circuit shown in the code translator shown in FIG. 1.

FIG. 4 is a timing diagram illustrating transactions on one embodiment of an interface between the code translator, the CPU, and the main memory shown in FIG. 1 based on the control circuit illustrated in FIG. 3.

FIG. 5 is a timing diagram illustrating transactions on a second embodiment of an interface between the code translator, the CPU, and the main memory shown in FIG. 1 based on the control circuit illustrated in FIG. 3.

FIG. 6 is a flowchart illustrating operation of a second embodiment of a control circuit shown in the code translator shown in FIG. 1.

FIG. 7 is a flowchart illustrating one embodiment of a code sequence returned by the code translator for a miss in the code buffer.

FIG. 8 is a timing diagram illustrating transactions on one embodiment of an interface between the code translator, the CPU, and the main memory shown in FIG. 1 based on the control circuit illustrated in FIG. 6.

FIG. 9 is a flowchart illustrating operation of one embodiment of a control program executed by the CPU shown in FIG. 1.

FIG. 10 is a flowchart illustrating operation of one embodiment of the code translator shown in FIG. 1.

FIG. 11 is a block diagram of a second embodiment of a system including a decompressor.

FIG. 12 is a block diagram of one embodiment of an address space, a CPU cache, and a decompression buffer.

FIG. 13 is a block diagram of one embodiment of a carrier medium.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

System Overview

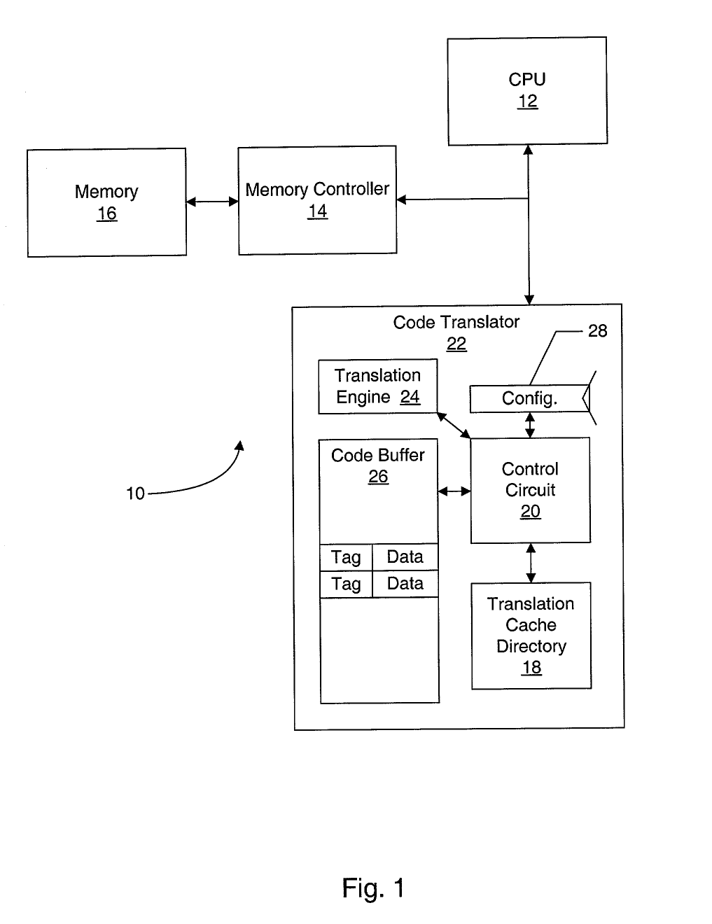

Turning now to FIG. 1, a block diagram of one embodiment of a system 10 is shown. Other embodiments are possible and contemplated. The illustrated system 10 includes a central processing unit (CPU) 12, a memory controller 14, a memory 16, and a code translator 22. The CPU 12 is coupled to the memory controller 14 and the code translator 22. The memory controller 14 is further coupled to the memory 16. In one embodiment, the CPU 12, the memory controller 14, and the code translator 22 may be integrated onto a single chip or into a package (although other embodiments may provide these components separately or may integrate any two of the components and/or other components, as desired).

Generally, the CPU 12 is capable of executing instructions defined in a first instruction set (the native instruction set of the system 10). The native instruction set may be any instruction set, e.g. the ARM instruction set, the PowerPC instruction set, the x86 instruction set, the Alpha instruction set, etc. The code translator 22 is provided for translating code sequences coded using a second instruction set, different from the native instruction set, to a code sequence coded using the native instruction set. Code sequences coded using the second instruction set are referred to as “non-native” code sequences, and code sequences coded using the first instruction set of the CPU 12 are referred to as “native” code sequences.

When the CPU 12 detects that a non-native code sequence is to be executed, the CPU 12 may communicate the source address of the beginning of the non-native code sequence to the code translator 22. The code translator 22 reads the non-native code sequence from the source address, translates the non-native code sequence to a native code sequence, and stores the native code sequence. More particularly, the translation engine 24 illustrated within the code translator 22 may perform the above activities. Once the translation is complete, the CPU 12 may execute the native code sequence.

In one embodiment, the code translator 22 may translate instructions beginning at the source address and until a terminating condition in the source code sequence is reached. For example, a terminating condition may be a non-native instruction which the code translator 22 is not configured to translate (e.g. because the instruction is too complex to translate efficiently). The non-native instruction may be emulated instead. As another example, a terminating condition may be a maximum number of instructions translated. The maximum number may be the number of source instructions (e.g. non-native instructions) or the number of translated instructions (e.g. native instructions). Alternatively, the number of bytes may be limited (and may be either the number of bytes of source instructions or the number or bytes of translated instructions). The maximum number of bytes/instructions may be programmable in a configuration register of the code translator 22 (not shown). In one particular implementation, for example, a maximum size of 64 or 128 bytes of translated code may be programmably selected. In another implementation, a maximum size of 512 bytes of translated code may be programmably selected. Any maximum size may be implemented in various embodiments.

The code translator 22 may attempt to handle branch instructions efficiently in translating code sequences. Unconditional branch instructions (which always branch to the branch target address) may be deleted (or “folded out”) of the translated code sequence. Instructions at the branch target address in the source code sequence may be inserted in the translated code sequence consecutive to instructions prior to the unconditional branch instruction. On the other hand, conditional branch instructions may cause instruction execution to continue with the sequential path or the target path, based on the results of some preceding instruction. Upon encountering a conditional branch instruction in the source code sequence, the code translator 22 may generate a translated branch instruction and may continue translation down one of the sequential path or target path of the conditional branch instruction within the source code sequence. The code translator may record the address of the other path within the source code sequence and the address of the translated branch instruction in the translated code sequence which corresponds to the branch instruction in the source code sequence. Upon reaching a terminating condition in the selected path, the code translator may translate one or more instructions from the other path. The translated instructions corresponding to the one or more instructions from the other path are inserted into the translated code sequence. Additionally, the code translator may code the translated branch instruction to generate a branch target address identifying the first instruction of the translated instructions corresponding to the other path (i.e. the branch target address is the address of the first instruction of the translated instructions). In this manner, a translated code sequence including instructions from both the target path and the sequential path of the conditional branch instruction may be generated. The branch instruction may be handled efficiently within the code sequence, rather than returning to a control program executed by the CPU 12 if the conditional branch instruction selects an untranslated path during execution.

In one embodiment, the code translator 22 is configured to translate Java code sequences to the native instruction set. Thus, Java bytecodes may be used as an example of a non-native instruction set below. However, the techniques described below may be used with any non-native instruction set. Furthermore, the term “instruction set” as used herein refers to a group of instructions defined by a particular architecture. Each instruction in the instruction set may be assigned an opcode which differentiates the instruction from other instructions in the instruction set, and the operands and behavior of the instruction are defined by the instruction set. Thus, Java bytecodes are instructions within the instruction set specified by the Java language specification, and the term bytecode and instruction will be used interchangeably herein when discussing Java bytecodes. Similarly, ARM instructions are instructions specified in the ARM instruction set, PowerPC instructions are instructions specified in the PowerPC instruction set, etc.

Generally, the CPU 12 executes native code sequences and controls other portions of the system in response to the native code sequences. More particularly, the CPU 12 may execute a control program which is used to communicate with the code translator 22 to control translation of code sequences. The code translator 22 may terminate each translated code sequence with an exit instruction which returns control to the control program. More particularly, the exit instruction may be an unconditional branch having a predefined target address within the control program. The predefined target address may be a routine which determines if an untranslated instruction or other exception condition has been encountered (and may handle the exception condition) and may further determine the next code sequence to be executed (if already translated and cached in the memory 16) or translated. The control program may handle untranslated instructions and other exception conditions with respect to the non-native code. In one embodiment in which the non-native instruction set is the Java instruction set, the control program may be part of the Java Virtual Machine (JVM) for the system 10. The JVM may include the interpreter mode to handle untranslated instructions and exception conditions detected by the code translator 22. The JVM executed by the CPU 12 may include all of the standard features of a JVM and may further include code to activate the code translator 22 when a Java code sequence is to be executed, and to jump to the translated code after code translator 22 completes the translation. The code translator 22 may insert a return instruction to the JVM at the end of each translated sequence. The CPU 12 may further execute the operating system code for the system 10, as well as any native application code that may be included in the system 10.

The memory controller 14 receives memory read and write operations from the CPU 12 and the code translator 22 and performs these read and write operations to the memory 16. The memory 16 may comprise any suitable type of memory, including SRAM, DRAM, SDRAM, RDRAM, or any other type of memory.

It is noted that, in one embodiment, the interconnect between the code translator 22, the CPU 12, and the memory controller 14 may be a bus (e.g. the Advanced RISC Machines (ARM) Advanced Microcontroller Bus Architecture (AMBA) bus, including the Advanced High-Performance (AHB) and/or Advanced System Bus (ASB)). Alternatively, any other suitable bus may be used, e.g. the Peripheral Component Interconnect (PCI), the Universal Serial Bus (USB), IEEE 1394 bus, the Industry Standard Architecture (ISA) or Enhanced ISA (EISA) bus, the Personal Computer Memory Card International Association (PCMCIA) bus, the Handspring Interconnect specified by Handspring, Inc. (Mountain View, Calif.), etc. may be used. Still further, the code translator 22 may be connected to the memory controller 14 and the CPU 12 through a bus bridge (e.g. if the code translator 22 is coupled to the PCI bus, a PCI bridge may be used to couple the PCI bus to the CPU 12 and the memory controller 14). In other alternatives, the code translator 22 may be directly connected to the CPU 12 or the memory controller 14, or may be integrated into the CPU 12, the memory controller 14, or a bus bridge.

As used herein, the term “code sequence” refers to a sequence of one or more instructions which are treated by the code translator 22 as a unit. For example, a code sequence may be installed into a translation cache as a unit (possibly extending across two or more cache blocks) and may be deleted from the translation cache as a unit. The translation cache may be the virtual translation cache described below, for example. A “source code sequence” is a code sequence using instructions in a first instruction set which may be translated by the code translator 22, and a “translated code sequence” is a code sequence using instructions in a second instruction set and which is the translation of at least a portion of the source code sequence. For example, in the system 10, the source code sequence may be coded using non-native instructions and the translated code sequence may be coded using native instructions.

As used herein, the term “translation” refers to generating one or more instructions in a second instruction set which provide the same result, when executed, as a first instruction in a first instruction set. For example, the one or more instructions may perform the same operation or operations on the operands of the first instruction to generate the same result the first instruction would have generated. Additionally, the one or more instructions may have the same effect on other architected state as the first instruction would have had.

Translation Caching

As mentioned above, the code translator 22 translates non-native code sequences into native code sequences. It may be generally desirable to retain the translated native code sequences for as long as possible, so that the translation need not be repeated if the corresponding non-native code sequences are to be executed again. However, storing the translated native code sequences in the memory 16 (the main memory of the system 10) reduces the amount of memory available for storing other code sequences to be executed by the CPU 12, data to be manipulated by the CPU 12, etc. The code translator 22 may support a virtual translation cache mechanism which may allow for storing translated native code sequences in the CPU's cache while not occupying memory for those same code sequences. The code translator 22 may include a control circuit 20, a translation cache directory 18, a code buffer 26, and one or more configuration registers 28 to provide the virtual translation cache.

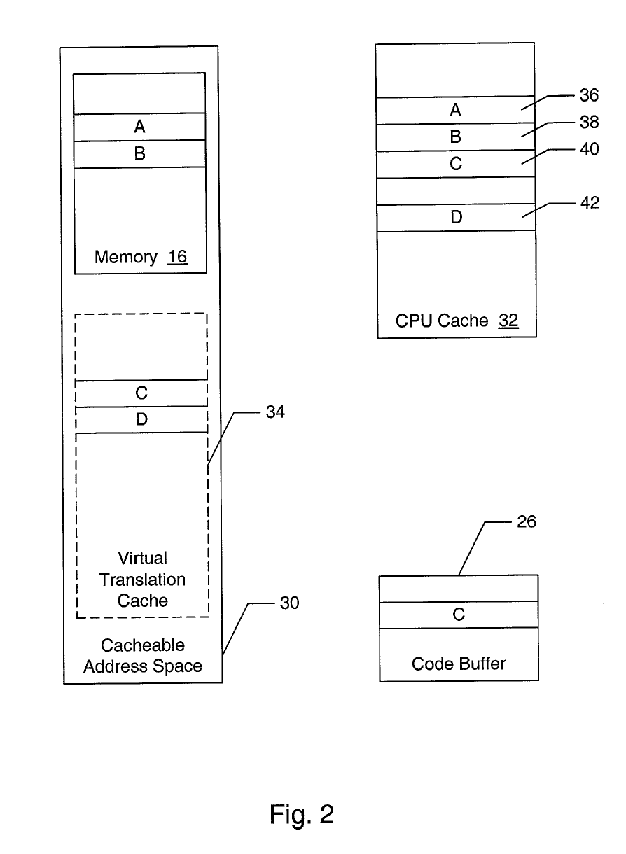

The concept of virtual caching will first be described with reference to FIG. 2, and a detailed discussion of certain embodiments will follow with reference to FIG. 1 and FIGS. 3-10. FIG. 2 is a block diagram illustrating a cacheable address space 30 of the system 10, a CPU cache 32, and the code buffer 26. The cacheable address space 30 includes a first address range mapped to the memory 16 as well as a second address range mapped to a virtual translation cache 34. The memory 16 exists physically in the system 10, and the data stored in the addressed storage locations is returned to the CPU 12 (for a read), or the data provided by the CPU 12 (for a write) is stored into the addressed storage locations. On the other hand, the virtual translation cache 34 may not exist physically, but may instead by a mechanism for the code translator 22 to provide translated native code sequences to the CPU cache 32 for storage. A relatively small code buffer 26 may be provided to temporarily store translated native code sequences until they can be transferred to the CPU cache 32 for storage. In this manner, the translated native code sequences can be cached in the CPU cache 32 (and used repeatedly by the CPU 12 as long as they are not cast out of the CPU cache 32) without occupying any storage in the memory 16.

As mentioned above, the virtual translation cache 34 may not physically exist. Instead, the directory for the virtual translation cache 34 (e.g. the translation cache directory 18 in FIG. 1) may provide mappings of source addresses of non-native code sequences to target addresses of corresponding translated native code sequences within the virtual translation cache 34. When a particular non-native code sequence which is not represented within the virtual translation cache 34 is translated, that code sequence may be assigned a location in the virtual translation cache 34 and the translation cache directory 18 may be updated. The address of the translated native code sequence is also provided to CPU 12 for fetching. The translated native code sequence may be stored into the code buffer 26. When the CPU 12 fetches the translated native code sequence for execution (using the address assigned to that code sequence by the code translator 22, wherein the address is within the address range corresponding to the virtual translation cache 34), the code translator 22 may detect the address and provide the translated native code sequence from the code buffer 26. The CPU cache 32 may allocate space to store the translated native code sequence, and may store the code sequence in the allocated space.

The CPU 12 may generate any of the addresses within the cacheable address space 30, and CPU cache 32 may cache any data corresponding to addresses within the cacheable address space 30. Thus, for example, blocks A and B within the memory 16 may be stored in the CPU cache 32 (reference numerals 36 and 38). Blocks C and D within the virtual translation cache 34 may be stored in the CPU cache 32 as well (reference numerals 40 and 42). Block C is also shown stored in the code buffer 26, but block D is not stored in the code buffer 26. Accordingly, the CPU cache 32 may be the only storage, in the example of FIG. 2, which is currently storing block D. If the CPU cache 32 replaces block D with some other information, and block D is subsequently required for execution by the CPU 12, then block D misses in the CPU cache 32. The code translator 22 may detect that the address presented by the CPU 12 in response to the cache miss in the CPU cache 32 is within the address range of the virtual translation cache 34. Since the code buffer 26 is also not storing block D, the code translator 22 may repeat the translation of the original source code sequence corresponding to block D to supply block D to the CPU cache 32 and/or the CPU 12 for execution.

In this manner, translated code sequences may be generated and cached in the CPU cache 32 without occupying the memory 16 and without requiring a memory the size of the virtual translation cache 34 to be included separate from the memory 16. Instead, the CPU cache 32 may store a relatively large number of translated code sequences. If the CPU cache 32 replaces a translated code sequence (or portion thereof), the translated code sequence may be regenerated. Efficient memory usage may be increased via the lack of storage of translated code sequences (which may be regenerated from the source code sequences) in the memory 16, while the CPU 12 may still receive the translated code sequences which hit in the CPU cache 32 rapidly (and thus performance in executing the translated code sequences may not be affected much by their lack of storage in the memory 16).

Generally, the CPU cache 32 may be any type of cache, including an instruction cache, a data cache, or a combined instruction/data cache. Any cache configuration may be used, including set associative, direct mapped, and fully associative configurations. Generally, the CPU cache 32 may include a set of cache block storage locations, each capable of storing a cache block. The CPU cache 32 may be integrated into the CPU 12, or may be a lower level cache external from the CPU 12 (e.g. attached to the interface between the CPU 12, the memory controller 14, and the code translator 22). The CPU cache 32 may store data for use by the CPU 12 (i.e. the CPU cache 32 responds to addresses requested by the CPU 12). The code buffer 26 may be a buffer configured to store at least one code sequence corresponding to a location of the virtual translation cache 34, and multiple code sequences may be stored in some embodiments. Any configuration may be used when multiple sequences are provided (e.g. fully associative, direct-mapped, or set associative).

It is noted that the “block” size for the virtual translation cache 34 (the size of the locations allocated and deallocated from the virtual translation cache 34 as a unit) may be larger than the cache block size in the CPU cache 32. For example, each location of the virtual translation cache may be capable of holding the largest possible translated code sequence. The CPU cache 32 may experience multiple cache block misses for a given translated code sequence and each cache block may be read from the code buffer 26 and stored into the CPU cache 32. If a given cache block corresponding to part of a translated code sequence is replaced, that translated code sequence can be retranslated from the source non-native code sequence and may be stored into the code buffer 26 to provide the missing cache block. It is further noted that a location in the virtual translation cache 34 is a set of contiguous addresses within the address range assigned to the virtual translation cache (since no physical storage may be allocated to the virtual translation cache). It is also noted that, if a newly generated translation is assigned a location of the virtual address cache 34 which was previously assigned to a different translated code sequence, the different translated code sequence is flushed from the CPU cache 32. Either hardware or software mechanisms may be used to accomplish the flush.

Returning to the embodiment of FIG. 1, the control circuit 20 may detect the addresses which are within the virtual translation cache 34 and may manage the virtual translation cache 34. The control circuit 20 is coupled to the translation engine 24 (the circuit which performs the non-native to native code translation), the configuration registers 28, the code buffer 26, and the translation cache directory 18.

The control circuit 20 monitors addresses transmitted by the CPU 12 to detect addresses in the address range corresponding to the virtual translation cache 34. If an address in the range is detected, control circuit 20 determines if the corresponding block is stored in the code buffer 26 and returns the block if it is stored there. If an address within the range is detected and the block is not stored in the code buffer 26, then the control circuit 20 determines the source address of the non-native code sequence corresponding to the translated code sequence which includes the missing block. The control circuit 20 may cause a translation of the source code sequence to be performed. The control circuit 20 may cause the translation to be performed directly or indirectly, as desired. Several embodiments are discussed below.

Additionally, the control circuit 20 may respond to translation commands which look up source addresses in the translation cache directory 18 (or alternatively a separate circuit may respond). The control circuit 20 may respond with a hit or miss indication, as well as the address of the translated code sequence (within the address range assigned to the virtual translation cache 34) if a hit is detected. Furthermore, the control circuit 20 may manage the allocation of locations within the virtual translation cache 34 for newly generated translations by managing the translation cache directory 18.

Generally, the code translator 22 may receive a translation command which includes the source address. In response to a translation command, the control circuit 20 may search the translation cache directory 18 to determine if a native code sequence corresponding to the source address has previously been generated and is still represented by an entry in the virtual translation cache 34. As used herein, the term “translation command” refers to a command transmitted to the code translator 22. In one embodiment, the translation command may comprise a command to lookup a source address in the virtual translation cache. The response to the command may be a hit/miss indication and the address in the virtual translation cache for the corresponding native code sequence, if a hit is detected. In another embodiment, the translation command may be a translation request (a request to translate a code sequence beginning at the source address). The response to the translation request may include searching the virtual translation cache and responding with hit information, and translating the non-native code sequence at the source address if a miss is detected.

In the illustrated embodiment, the configuration registers 28 may be used to store information identifying the address range assigned to the virtual translation cache 34. For example, a base address and size may be encoded, or a lower limit address and upper limit address may be encoded. Any suitable indication may be used. Alternatively, the address range for the virtual translation cache 34 may be predetermined, eliminating the configuration registers 28.

As illustrated in FIG. 1, the code buffer 26 comprises at least one entry, and may comprise multiple entries. Each entry is capable of storing the maximum code sequence size (e.g. each entry may match the size of a location in the virtual translation cache 34). Thus, each entry is capable of storing at least one cache block. The number of cache blocks per entry may be based on a ratio of the size of a location in the virtual translation cache 34 to the size of a cache block. Each entry may include storage for the code sequence (“data” in FIG. 1) as well as a tag. The tag is the address of the location within the virtual translation cache 34 to which the entry corresponds. Thus, each entry in the code buffer 26 may be mapped to any location within the virtual translation cache 34. Generally, when an entry of the code buffer 26 is remapped to correspond to a different location in the virtual translation cache (in response to a translation performed by the translation engine 24), the translated code sequence corresponding to the previous mapping of that entry is overwritten with the translated code sequence corresponding to the new mapping. However, the translated code sequence corresponding to the previous mapping may remain stored in the CPU cache 32. In other words, a translated code sequence which is overwritten in the code buffer 26 is not invalidated in the CPU cache 32 due to being invalidated in the code buffer 26. In this manner, translated code sequences represented in the virtual translation cache 34 may remain stored in the CPU cache 32 even if not stored in the code buffer 26.

The virtual translation cache 34 may have any suitable organization (e.g. direct mapped, set associative, or fully associative) for its locations, generally indexed by the source address of the non-native code sequence which is translated to the corresponding translated code sequence. The locations may be arranged in the address range assigned to the virtual cache 34 in any suitable fashion. For example, in one implementation, a set associative configuration may be used. The locations of a given set may be in contiguous addresses of the address range, with the locations of set 0 being at the least significant addresses of the range, followed by set 1, etc. In such a format, the target address for a given source address may be implied by the location in the virtual translation cache 34 in which a hit is detected for that source address. For such an embodiment, the translation cache directory entries may include a valid bit and the source address, with the target address within the virtual translation cache 34 being derived from the translation cache directory entry which hits.

It is noted that either or both of the translation cache directory 18 or the code buffer 26 may be implemented within reserved locations of the memory 16. Such embodiments would occupy some of the memory 16, but may still occupy less than the virtual translation cache 34 occupies.

Control Circuit, First Embodiment

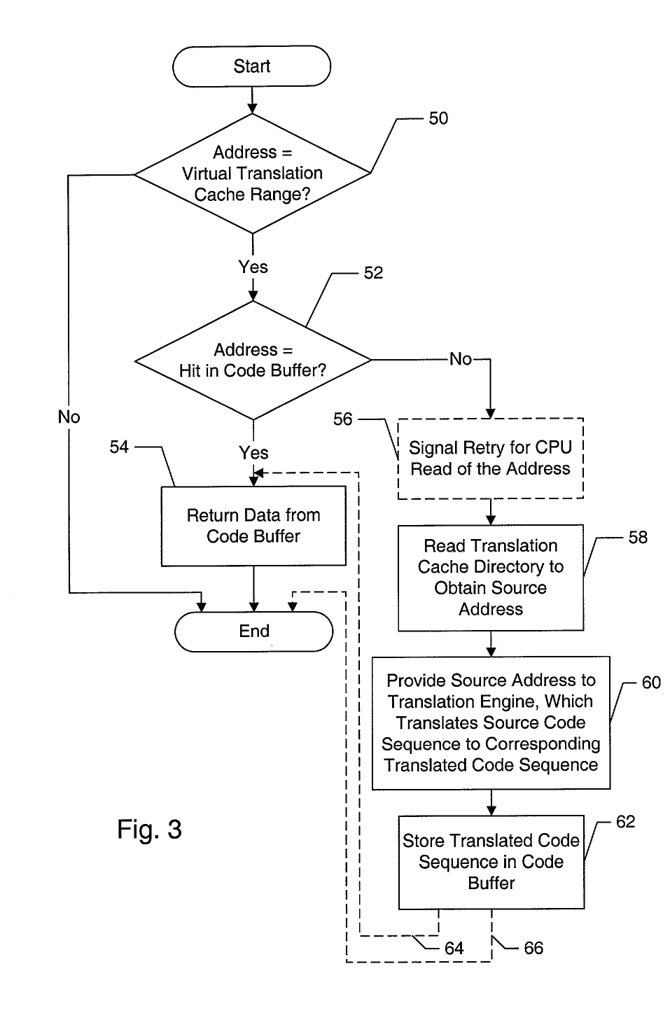

Turning now to FIG. 3, a flowchart is shown illustrating operation of one embodiment of the control circuit 20 in response to addresses presented by the CPU 12 on the interface therebetween. Addresses presented by the CPU 12 on the interface miss in the CPU cache 32 (since it is integrated into the CPU 12). In embodiments in which the CPU cache 32 is external to the CPU 12, the control circuit 20 may determine if the address is a miss in the CPU cache 32 before attempting to return data or cause a translation. Other embodiments are possible and contemplated. While the blocks shown in FIG. 3 are illustrated in a particular order for ease of understanding, any order may be used. Furthermore, blocks may be performed in parallel in combinatorial logic within the control circuit 20.

The control circuit 20 is coupled to receive an address presented by the CPU 12, and the control circuit 20 determines if the address is in the address range assigned to the virtual translation cache 34 (decision block 50). If the address in not in the range, then control circuit 20 may take no additional action in response to the address.

If the address is in the range, then the control circuit 20 may determine if the address is a hit in the code buffer 26 (decision block 52). Alternatively, whether or not the address is in the range may not affect whether or not a hit is detected in the code buffer 26. In other words, the control circuit 20 may compare the address to the tags of the code sequences stored in the code buffer 26 to determine if the address is within the code sequences stored therein. If so, the requested block is read form the code buffer 26 and returned to the CPU 12 (and/or the CPU cache 32) (block 54).

If the address is in the range and not a hit in the code buffer 26, then the control circuit 20 may, in some embodiments, signal a retry on the interface between CPU 12 and code translator 22 (e.g. through a bus interface unit within the code translator 22, not shown) (block 56). Block 56 is optional, and may be performed in embodiments in which the interface supports a retry capability (in which the transaction initiated by the CPU 12 and which includes the address presented by the CPU 12 is cancelled and reattempted by the CPU 12 at a later time). By retrying the transaction, the interface may be freed for the code translator 22 to read the source (non-native) code sequence corresponding to the address for retranslation to the corresponding translated (native) code sequence (which includes the block being requested by the CPU 12). Other embodiments may be used, for example, in interfaces that allow data transfers to occur out of order with respect to the address transfers.

Additionally, the control circuit 20 may read the translation cache directory 18 to determine the source address which corresponds to the address presented by the CPU 12 (i.e. the source address of the non-native code sequence which was translated to the translated code sequence which includes the block corresponding to the address presented by the CPU 12) (block 58). In other words, a reverse lookup may be performed in the translation cache directory 18 to find the source address which is mapped to the code sequence in the virtual translation cache 34. For the embodiment described above in which the address within the virtual translation cache 18 indicates which virtual translation cache entry is being accessed, the translation cache directory entry to be read to obtain the source address is derived from the address presented by the CPU 12 (within the address range of the virtual translation cache 34). In other embodiments, the translation cache directory 18 may store the target address and the source address, and the target address may be stored in a content addressable memory (CAM) structure which may receive the address presented by the CPU as input. In other alternatives, the source address may be retained from the previous translation cache lookup performed by the CPU to obtain the target address within the virtual translation cache 34, and the source address may be used when the target address is presented by the CPU 12 (in response to a miss in the CPU cache 32) and the target address misses in the code buffer 26.

The control circuit 20 provides the source address to the translation engine 24, which translates the source code sequence to a translated code sequence (block 60). The translated code sequence is then stored in the code buffer 26 (block 62). It is noted that, in another alternative, the code translation may be performed entirely in software (e.g. executed by the CPU 12) and thus the code translator 22 may provide management of the virtual translation cache 34 using the control circuit 20, the translation cache directory 18, and the code buffer 26 but the translation engine 24 may be omitted.

With the translated code sequence stored into the code buffer 26, various embodiments are contemplated. For example, in embodiments in which data transfers on the interface between the CPU 12 and the code translator 22 can occur out of order with respect to the address transfers of transactions, the data corresponding to the address presented by the CPU 12 may be returned to the CPU 12 (arrow 64). In embodiments in which the CPU 12 transaction was retried (block 56), the CPU 12 may subsequently reattempt the transaction and then a hit in the code buffer 26 may be detected. In such embodiments, the control circuit 20 may perform no further action in response to the original address after storing the data in the code buffer (arrow 66).

It is noted that various blocks shown in FIG. 3 may be performed in different clock cycles, as desired. Specifically, in one implementation, the decision blocks 50 and 52 may occur in a first clock cycle (or separate clock cycles), followed by a second clock cycle in which the block 54 is performed, a third clock cycle in which the blocks 56 and 58 are performed (or these blocks may be performed in separate clock cycles), followed by one or more clock cycles in which block 60 is performed and a fourth clock cycle in which block 62 is performed. One or more clock cycles may intervene between the various clock cycles above, as desired, according to design choice.

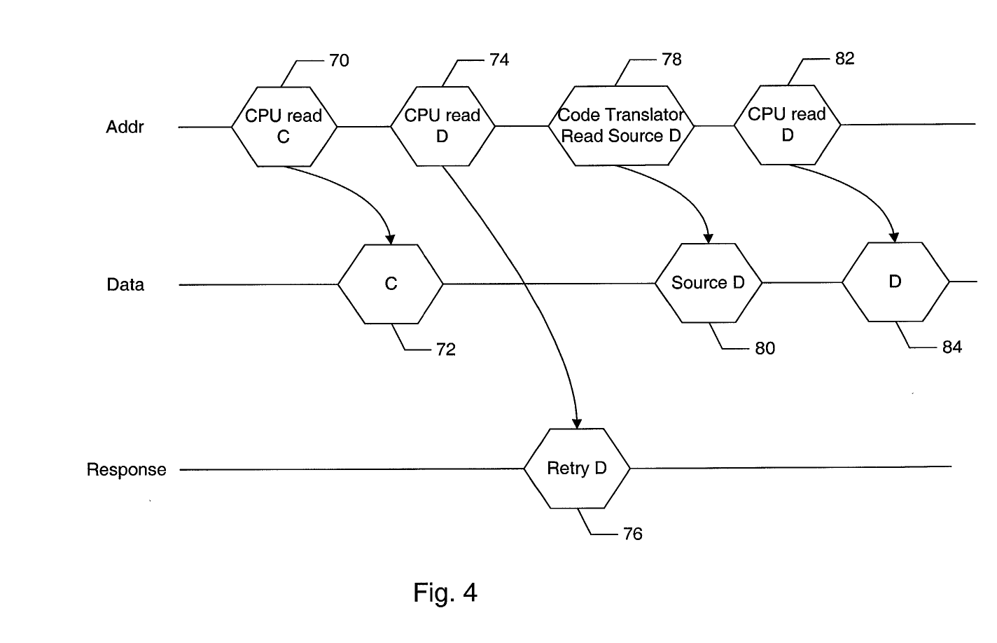

Turning next to FIG. 4, a timing diagram is shown illustrating a generalized operation of one embodiment of an interface between the CPU 12 and the code translator 22. The embodiment of FIG. 4 shows separate address and data buses and response lines, although other embodiments may multiplex the address and data buses and/or integrate the response lines with the address bus and/or data bus. The actual control signals and protocol used in the interface may be any suitable set of control signals and protocols. The interface of FIG. 4 supports retrying of transactions.

The example of FIG. 4 uses the blocks shown in FIG. 2 to illustrate operation of the bus. Thus, blocks C and D are blocks in the virtual translation cache 34. For purposes of this example, blocks C and D will be assumed to miss in the CPU cache 32 (unlike in FIG. 2, in which these blocks are illustrated as stored in the CPU cache 32). Block C will be assumed to be stored in the code buffer 26 and block D will not be stored in the code buffer 26 (e.g. similar to the illustration of FIG. 2).

The CPU initiates a transaction to read block C, since block C misses in the CPU cache 32. The address transfer is shown at reference numeral 70. Since the code buffer 26 is storing block C, the code translator 22 supplies block C on the data bus (reference numeral 72). However, when the CPU initiates a transaction to read block D (reference numeral 74), the control circuit 20 determines that block D misses in the code buffer 26 (and block D is in the address range assigned to the virtual translation cache 34). Accordingly, the code translator 22 retries the transaction to read block D (reference numeral 76). Subsequently, the code translator 22 initiates a transaction to read the source address corresponding to block D (as determined by the reverse lookup in the translation cache directory 18) to perform the translation (reference numeral 78). The corresponding data is supplied to the code translator 22 by the memory controller 14 (reference numeral 80). In other words, the source (non-native) code sequences are stored in the memory 16 and read therefrom by the code translator 22 to generate corresponding translated code sequences. Subsequently, the CPU 12 reattempts the transaction to read block D (reference numeral 82) and block D is supplied by the code translator 22 from the code buffer 26 (reference numeral 84).

It is noted that multiple transactions may be required to read the source code sequence for translation, depending on the size of the sequence and the amount of data that may be transferred in one transaction. Similarly, multiple transactions may be used to transfer the translated code sequence to the CPU 12 (and the CPU cache 32) dependent on the size of the sequence and the amount of data that may be transferred in one transaction. Furthermore, it is possible that the CPU 12 may reattempt the transaction to read block D before the translation is complete. If so, the code translator 22 may retry the transaction again until the block is available in the code buffer 26.

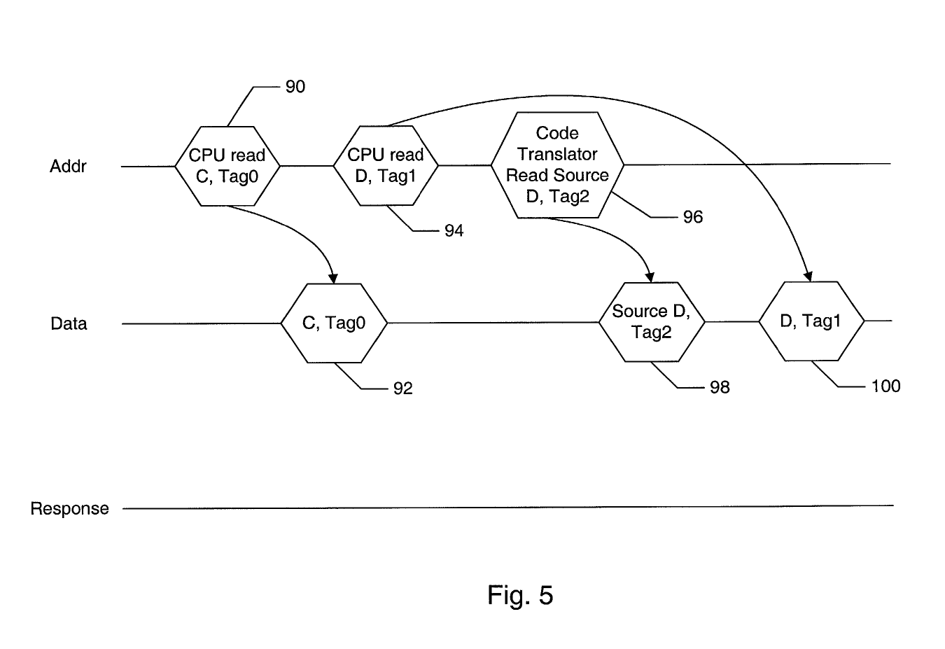

Turning next to FIG. 5, a timing diagram is shown illustrating a generalized operation of a second embodiment of an interface between the CPU 12 and the code translator 22. The embodiment of FIG. 5 shows separate address and data buses and response lines, although other embodiments may multiplex the address and data buses and/or integrate the response lines with the address bus and/or data bus. The actual control signals and protocol used in the interface may be any suitable set of control signals and protocols. The embodiment of FIG. 5 supports out of order data transfers with respect to the order of the address transfers through the use of tagging (e.g. each address transfer is assigned a tag by the initiator and the data is returned using the same tag so that the address and corresponding data transfers may be identified). Other embodiments may use other mechanisms for providing out of order transfers.

The example of FIG. 5 uses the blocks shown in FIG. 2 to illustrate operation of the bus. Thus, blocks C and D are blocks in the virtual translation cache 34. For purposes of this example, blocks C and D will be assumed to miss in the CPU cache 32 (unlike in FIG. 2, in which these blocks are illustrated as stored in the CPU cache 32). Block C will be assumed to be stored in the code buffer 26 and block D will not be stored in the code buffer 26 (e.g. similar to the illustration of FIG. 2).

The CPU initiates a transaction to read block C, since block C misses in the CPU cache 32. The CPU assigns a tag (“tag0”) to the transaction. The address transfer is shown at reference numeral 90. Since the code buffer 26 is storing block C, the code translator 22 supplies block C on the data bus (reference numeral 92), using tag0 to link the data transfer to the address transfer initiated by the CPU. However, when the CPU initiates a transaction to read block D (reference numeral 94), the control circuit 20 determines that block D misses in the code buffer 26 (and block D is in the address range assigned to the virtual translation cache 34). The CPU 12 assigns a different tag (“tag1”) to the address transfer to request block D. Since block D is not stored in the code buffer 26, the code translator 22 does not immediately return the data to the CPU 12. Instead, the code translator 22 initiates a transaction to read the source address corresponding to block D (as determined by the reverse lookup in the translation cache directory 18) to perform the translation (reference numeral 96). The code translator assigns a tag (“tag2”) to the transaction. The corresponding data is supplied to the code translator 22 by the memory controller 14 (reference numeral 98), using tag2 to link the data to the corresponding address transfer. Subsequently, the code translator 22 returns block D to the CPU 12 (after translating the source code sequence to the target code sequence), using the tag1 to link the data transfer to the corresponding address transfer (reference numeral 100). As mentioned above, multiple transactions may be required to read the source code sequence for translation and to transmit the translated code sequence to the CPU 12 (and the CPU cache 32), depending on the size of the sequence and the amount of data that may be transferred in one transaction.

Control Circuit, Second Embodiment

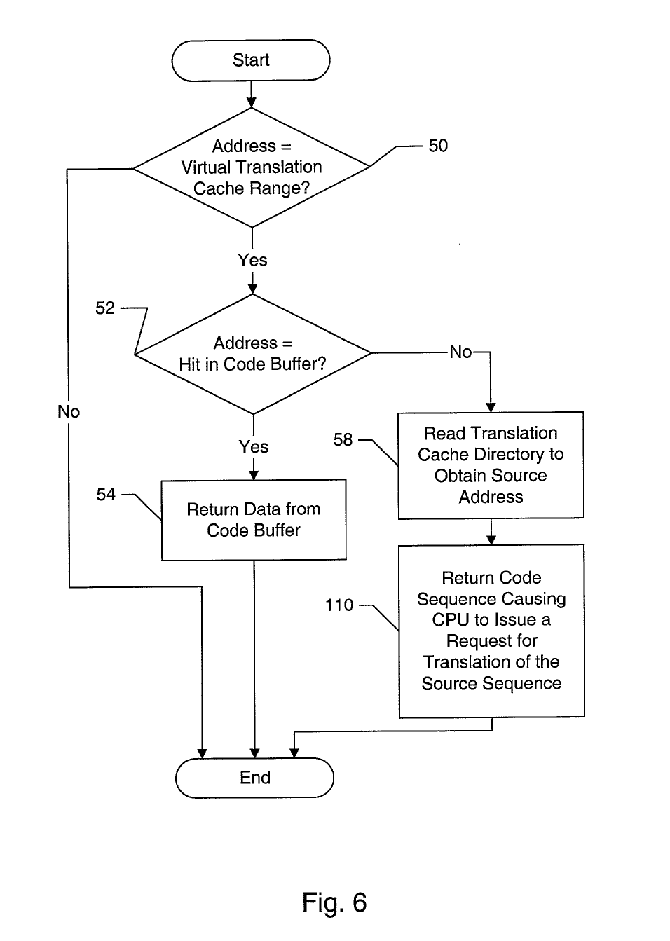

Turning now to FIG. 6, a flowchart illustrating operation of a second embodiment of the control circuit 20 in response to addresses presented by the CPU 12 on the interface therebetween is shown. Addresses presented by the CPU 12 on the interface miss in the CPU cache 32 (since it is integrated into the CPU 12). In embodiments in which the CPU cache 32 is external to the CPU 12, the control circuit 20 may determine if the address is a miss in the CPU cache 32 before attempting to return data or cause a translation. Other embodiments are possible and contemplated. While the blocks shown in FIG. 6 are illustrated in a particular order for ease of understanding, any order may be used. Furthermore, blocks may be performed in parallel in combinatorial logic within the control circuit 20. As mentioned above with respect to FIG. 3, blocks may be performed in different clock cycles in the embodiment of FIG. 6.

The control circuit 20 may determine if the address is within the address range assigned to the virtual translation cache 34, if the address hits in the code buffer 26, and may return the block from the code buffer 26 if a hit is detected, similar to the embodiment illustrated in FIG. 3 (decision blocks 50 and 52 and block 54). If the address is in the address range assigned to the virtual translation cache 34 and the address is a miss in the code buffer 26, then the control circuit may read the translation cache directory 18 to obtain the source address, again similar to the embodiment of FIG. 3 (block 58).

However, instead of initiating the translation directly by providing the source address to the translation engine 24, the embodiment of FIG. 6 returns a code sequence in response to the missing address (in place of the translated code sequence). The code sequence causes the CPU to issue a request for translation using the source address (block 110). In other words, the code sequence returned instead of the translated code sequence may perform the same operations as may be performed when a source code sequence is translated for the first time. In this manner, the translated code sequence may be regenerated. The code sequence returned in block 110 may then branch to the translated code sequence, causing the CPU 12 to read the translated code sequence (and the translated code sequence may be cached in the CPU cache 32).

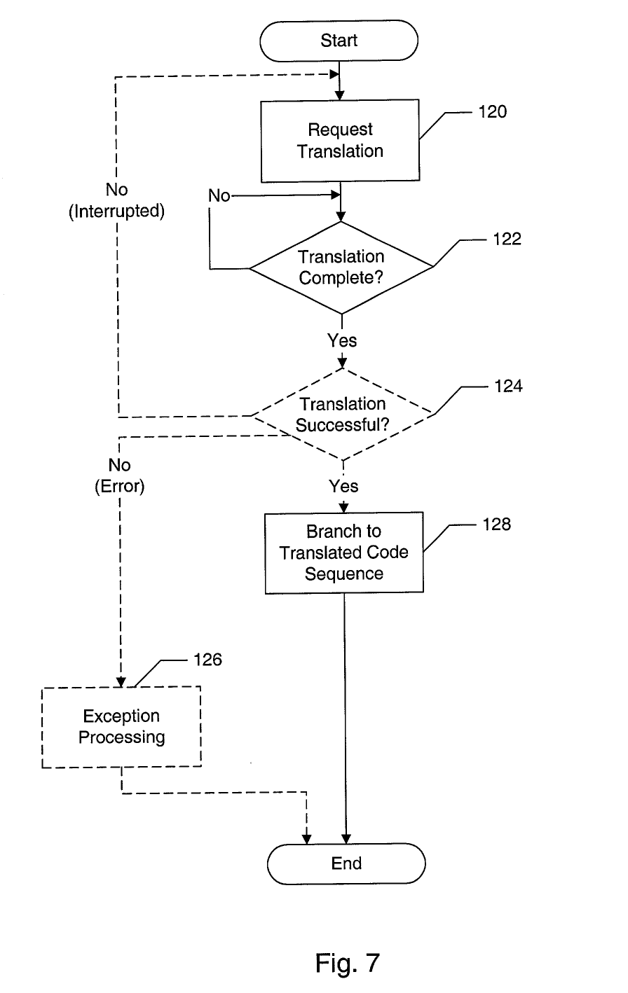

Turning next to FIG. 7, a flowchart illustrating the code sequence executed by the CPU 12 when the code sequence to request a translation is returned in block 110 is shown. Other embodiments are possible and contemplated. Although the blocks in FIG. 7 are illustrated in a particular order for ease of understanding, any suitable order may be used, as desired. The control circuit 20 may actually return only a portion of the code sequence shown in FIG. 7, or a code sequence which branches to the code sequence shown in FIG. 7 and provides the source address as an operand to the code sequence shown in FIG. 7.

The code sequence includes one or more instructions to request a translation (block 120). In one embodiment, the instructions to request translation may include a store to a memory-mapped address which is recognized by the code translator 22 as a translation command (specifically, a request for translation). The data provided by the store instruction may be the source address to be translated.

The code sequence may include one or more instructions to poll the code translator 22 to determine if the translation is complete (decision block 122). If the translation is not complete, then the code sequence may continue polling. In one embodiment, the instructions to determine if the translation is complete may include a load instruction to a memory-mapped address which is recognized by the code translator 22 as a translation command (specifically, a translation status command). The value provided by the code translator 22 in response to the load may be an indication of whether or not the translation is complete and, if complete, a success or failure indication for the translation. The one or more instructions may further include instructions to process the value to determine if the translation is complete.

If the translation is complete, the code sequence may optionally determine if the translation was successful (decision block 124). The check for success may be optional since the translation was previously performed and was successful, or it would not have been stored in the virtual translation cache 34. There may be a variety of reasons for lack of success, including untranslatable non-native instructions, invalid non-native instructions, etc. Many of these failing conditions would have been detected the first time the code sequence was translated. However, performing the check for success may guard against corruption of the non-native code sequences in memory (e.g. by modification or error in the system 10). Additionally, in one embodiment, the code translator 22 includes support allowing multiple processes operating on CPU 12 to use the code translator 22. Each process may be assigned different service ports (addressed using different addresses) to allow code translator 22 to differentiate between requests corresponding to different processes. Use of the code translator 22 by a different process during the retranslation effort could cause a translation to fail temporarily, even if it succeeded previously.

If the failure is due to interruption by another process, the code sequence may request the translation again (block 120). If the failure is due to error, the code sequence may branch to exception processing (block 126). If the translation succeeds, then the code sequence may branch to the translated code sequence (block 128). Branching to the code sequence causes the CPU to fetch the retranslated code sequence, which may then be stored in the CPU cache 32 as well. The retranslated code sequence may be terminated by the exit instruction, returning control to the control program executing on the CPU 12 (e.g. the JVM, in embodiments in which Java is the non-native instruction set).

As mentioned above, the control circuit 20 may not return all of the code sequence shown in FIG. 7 as the code sequence returned at block 110. Since the code sequence shown in FIG. 7 is provided to the CPU 12 as the contents of the location in the virtual translation cache 34 which corresponds to the translated code sequence generated in response to the operation of the code sequence shown in FIG. 7, the code sequence would be overwritten in the virtual translation cache 34 (and invalidated in the CPU cache 32) when the translation of the source code sequence is completed and the translated code sequence is stored into the code buffer 26 (as part of the coherency management discussed above). Since the code sequence shown in FIG. 7 may perform activities after the translation is complete, invalidation of the sequence before it is complete could lead to improper operation.

In one contemplated embodiment, the code illustrated by the flowchart of FIG. 7 is stored at a fixed or programmable address, and the code returned by the code translator 22 in block 110 may be a branch to the code illustrated in FIG. 7. In such an embodiment, the translated code sequence may be provided at the same address in the virtual translation cache 34 as it was previously stored without overwriting the code sequence shown in FIG. 7. Alternatively, other embodiments may relocate the translated code sequence to another location in the virtual translation cache 34 when a retranslation occurs, thus not overwriting the sequence shown in FIG. 7 within the virtual translation cache 34. Still further, embodiments in which the code sequence merely requests translation may be returned and may operate properly, since the code sequence can be overwritten by the retranslated code sequence.

As mentioned above, the CPU cache 32 may be invalidated by the code translator 22 when a location in the virtual translation cache 34 is allocated to a translation (to ensure that previously translated code that may be stored at that location is deleted from the CPU cache 32). The interface between the CPU 12 and the code translator 22 may support coherency, such that commands thereon may cause the invalidation, or the code sequence which requests a new translation (or retranslation) may cause the invalidation in software.

Furthermore, embodiments are contemplated in which the control circuit 20 returns a code sequence to cause the retranslation of a previously translated code sequence but which do not perform the translation in hardware. In such embodiments, the flowchart of FIG. 7 may be expanded to include instructions to perform the translation.

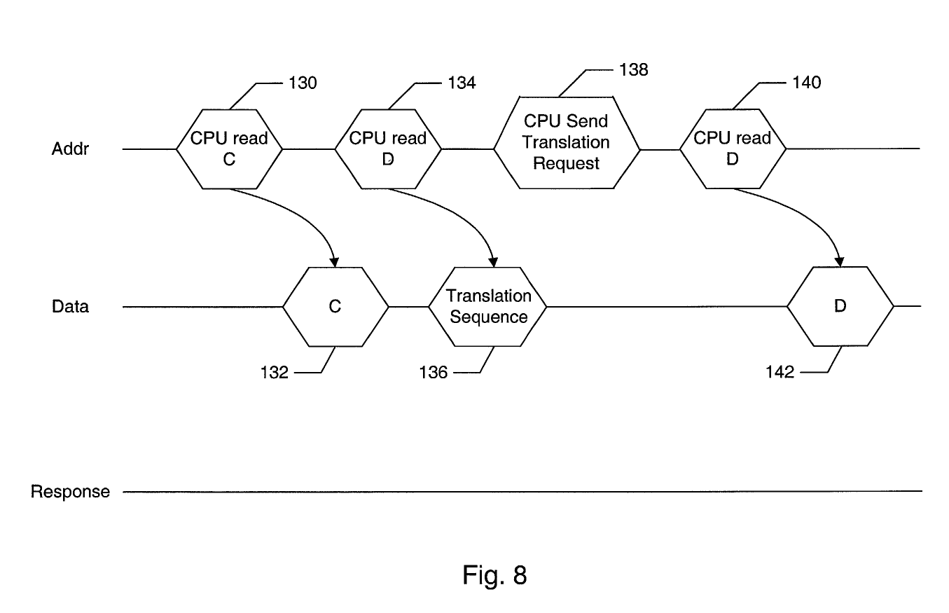

Turning next to FIG. 8, a timing diagram is shown illustrating a generalized operation of one embodiment of an interface between the CPU 12 and the code translator 22. The embodiment of FIG. 8 shows separate address and data buses and response lines, although other embodiments may multiplex the address and data buses and/or integrate the response lines with the address bus and/or data bus. The actual control signals and protocol used in the interface may be any suitable set of control signals and protocols.

The example of FIG. 8 uses the blocks shown in FIG. 2 to illustrate operation of the bus. Thus, blocks C and D are blocks in the virtual translation cache 34. For purposes of this example, blocks C and D will be assumed to miss in the CPU cache 32 (unlike in FIG. 2, in which these blocks are illustrated as stored in the CPU cache 32). Block C will be assumed to be stored in the code buffer 26 and block D will not be stored in the code buffer 26 (e.g. similar to the illustration of FIG. 2).

The CPU initiates a transaction to read block C, since block C misses in the CPU cache 32. The address transfer is shown at reference numeral 130. Since the code buffer 26 is storing block C, the code translator 22 supplies block C on the data bus (reference numeral 132). However, when the CPU initiates a transaction to read block D (reference numeral 134), the control circuit 20 determines that block D misses in the code buffer 26 (and block D is in the address range assigned to the virtual translation cache 34). Accordingly, the code translator 22 returns the translation code sequence which causes a translation request to be initiated by the CPU 12 instead of the translated code sequence (reference numeral 136). Subsequently, the CPU 12 transmits a request for translation (reference numeral 138). Not shown in FIG. 8, the code translator 22 reads the source address and performs the translation, similar to reference numerals 78 and 80 and the discussion thereof in FIG. 4. Once the translation is complete, a branch to the translated code is executed, which causes the CPU to fetch block D again (reference numeral 140). The corresponding data is supplied to the code translator 22 by the memory controller 14 (reference numeral 142).

It is noted that the interface of FIG. 8 may, in some embodiments, have the functionality of either of the interfaces illustrated in FIGS. 4 and 5, or both. Other embodiments may not support retry or out of order data transfers, as desired.

Additional Translation Operation

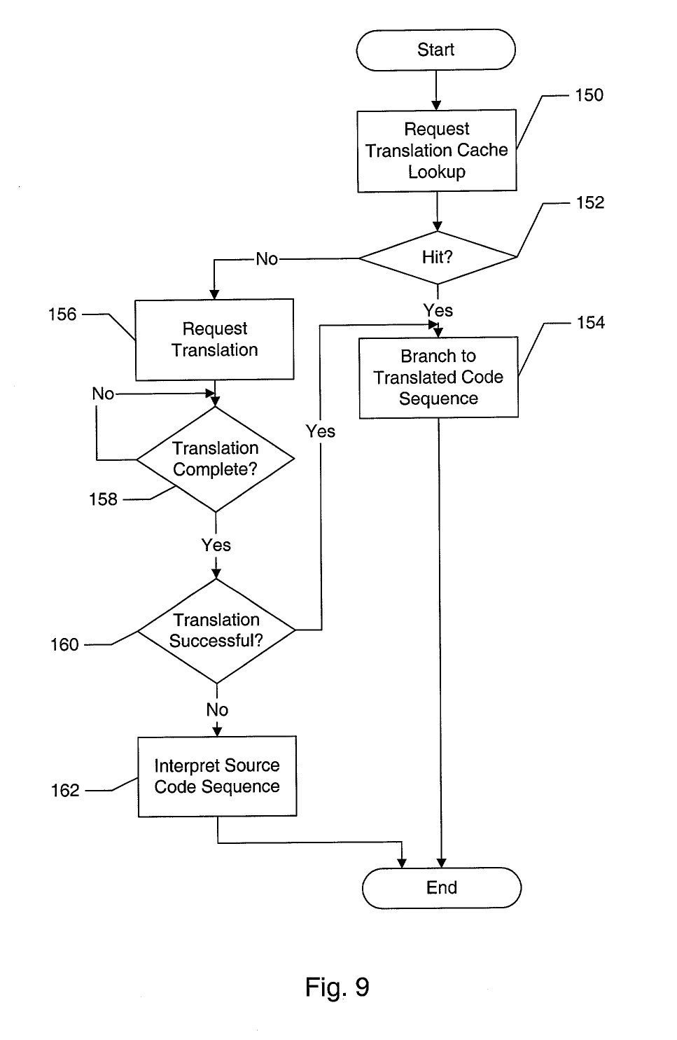

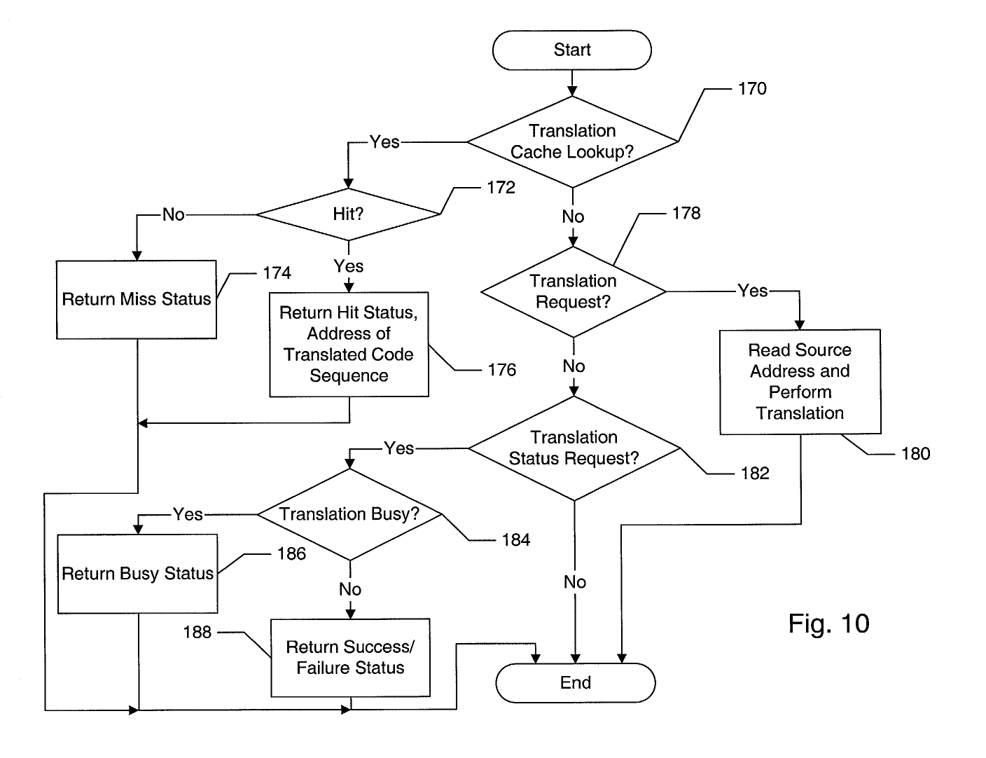

Turning next to FIGS. 9 and 10, flowcharts are shown illustrating one embodiment of basic translation operation. Other embodiments are possible and contemplated. FIG. 9 is a flowchart illustrating operation of a portion of one embodiment of a control program which may execute on the CPU 12 (e.g. the JVM, for embodiments in which Java is the non-native instruction set). FIG. 10 is a flowchart illustrating other operation of one embodiment of the code translator 22.

The flowchart shown in FIG. 9 illustrates the portion of the control program used to interface to the code translator 22 when a translation of a non-native code sequence is desired. Thus, the control program may request a translation cache lookup to determine if the non-native code sequence has already been translated (block 150). For example, the translation cache lookup request may include: (i) a store instruction to a memory-mapped address recognized by the code translator 22 as a translation cache lookup, with the data for the store being the source address; and (ii) a load instruction to the memory-mapped address. The code translator 22 may return, as the data for the load, a hit/miss indication and the address of the corresponding translated code sequence (if a hit is indicated).

Thus, the control program may examine the result of the translation cache lookup. If a hit is indicated (decision block 152), then the control program may branch to the translated code sequence (block 154). The branch to the translated code sequence may miss in the CPU cache 32, if the translated code sequence has been replaced in the CPU cache 32, and thus may result in the translated code sequence being provided from the code buffer 26 or the retranslation of the corresponding source code sequence. In the second embodiment of the control circuit 20, the branch to the translated code sequence may actually result in a code sequence to request the translation, if the translated code sequence is a miss in the CPU cache 32 and the code buffer 26.

On the other hand, if a miss is indicated in the result of the translation cache lookup, the control program may request a translation of the non-native code sequence (block 156). The control program may then poll the code translator 22 to determine if the translation is complete (decision block 158). Once the translation is complete, the control program may determine if the translation was successful (decision block 160). If the translation was successful, the control branch may branch to the translated code sequence (block 154). On the other hand, if the translation was not successful, the control program may execute the source (non-native) code sequence in an interpreter mode (block 162). Optionally, in some embodiments, a cause of unsuccessful translation may be the interruption of the translation to service another process executing on the CPU 12. In such and embodiment, a request to translate may be repeated if the reason for failure was interruption.

FIG. 10 illustrates various functionality of the code translator 22. Any circuitry within the code translator 22 may perform the various operations shown in FIG. 10, including the control circuit 20, the translation engine 24, or combinations thereof. While the blocks shown in FIG. 10 are illustrated in a particular order for ease of understanding, any suitable order may be used. Furthermore, blocks may be performed in parallel in combinatorial logic within the code translator 22. Particularly, blocks 170, 178, and 182 may be independent and parallel.

The code translator 22 may detect a translation cache lookup command (decision block 170). If a translation cache lookup command is detected, the code translator 22 may determine if the source address provided is a hit in the virtual translation cache 34 by reading the translation cache directory 18 (decision block 172). If a miss is detected, the code translator 22 may return a miss status (block 174). On the other hand, if a hit is detected, the code translator 22 may return a hit status and the address of the translated code sequence (within the virtual translation cache 34—block 176). It is noted that, in one embodiment, control circuit 20 may capture the source address when the hit in the translation cache 34 is detected, to avoid a reverse lookup in the translation cache directory 18, if desired.

The code translator 22 may detect a translation request (decision block 178). If a translation request is detected, then the code translator 22 may read the source address and perform the translation (block 180). As noted above, performing a translation and storing the translation in the code buffer 26 may include invalidating the address of the translated code sequence in the CPU cache 32 to ensure coherency.

The code translator 22 may detect a translation status request (decision block 182). If a translation status request is detected and the translation is busy (not complete—decision block 184), then the code translator 22 returns a busy status (block 186). If a translation status request is detected and the translation is not busy, then the code translator 22 returns a success or failure status for the translation (block 188).

Decompression Embodiment

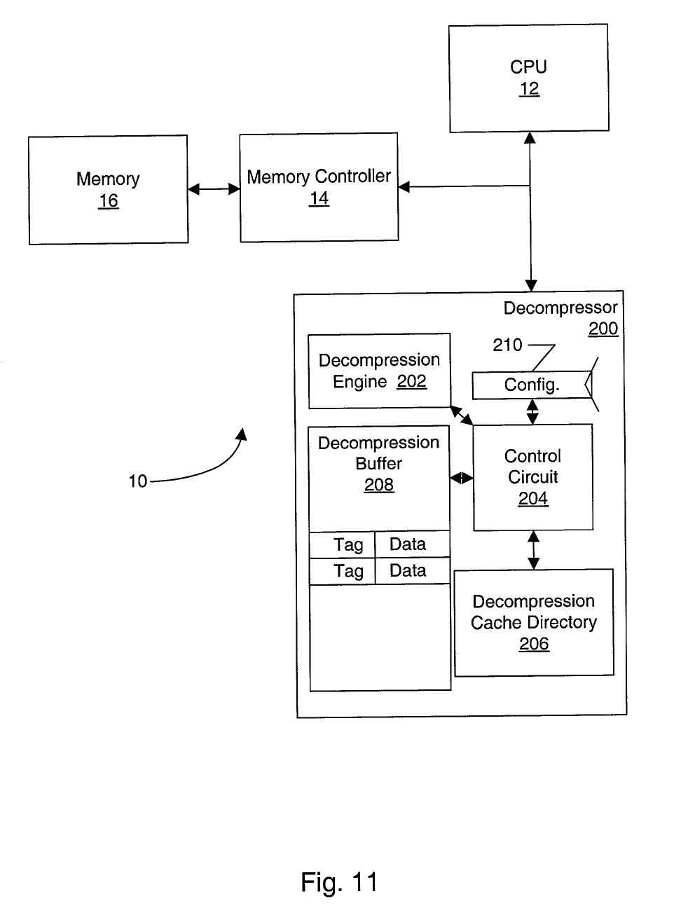

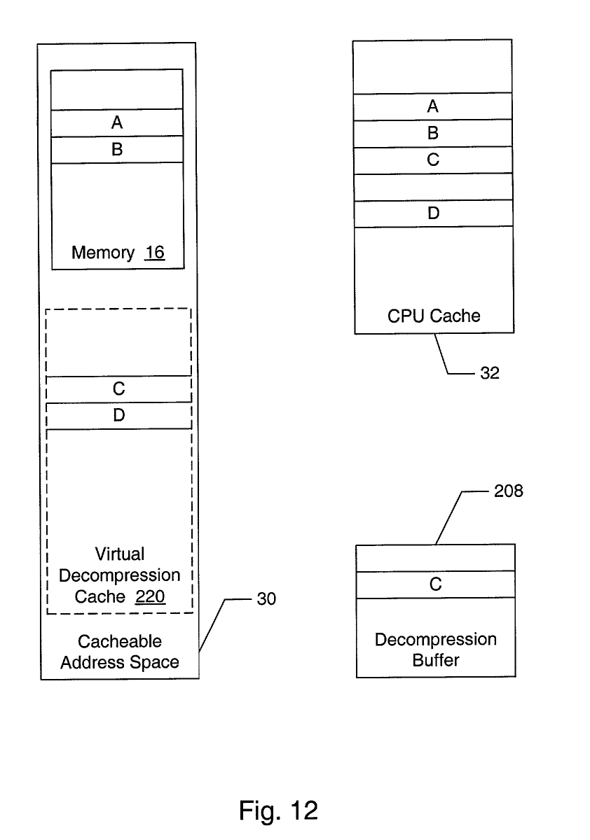

Turning now to FIGS. 11 and 12, a second embodiment of the system 10 is shown. Similar to the embodiment of FIG. 1, the system 10 includes the CPU 12, the memory controller 14, and the memory 16. However, in place of the code translator 22, the embodiment of FIG. 11 includes a decompressor 200. The decompressor 200 may include a decompression engine 202, a control circuit 204, a decompression cache directory 206, a decompression buffer 208, and a set of one or more configuration registers 210. The control circuit 204 is coupled to the decompression engine 202, the decompression buffer 208, the decompression cache directory 206, and the configuration registers 210.

The embodiment of FIGS. 11 and 12 may be configured to perform decompression rather than code translation. For example, in some smart card systems, read-only memory (ROM) or flash memory may be included (not shown) and may store program code for execution by the CPU 12 or various operand data to be operated upon by the CPU 12 (e.g. user data, passwords, etc.) The memory may store the data (code/operand data) in compressed form, and the data may be decompressed as needed for use by the CPU 12. Other decompression embodiments not used in smart card systems are contemplated as well.

Similar to the code translation embodiments above, the decompressor 200 may be configured to decompress compressed data into corresponding uncompressed data, and may store the uncompressed data in a virtual decompression cache. Specifically, in the illustrated embodiment, the decompressor 200 includes the decompression engine 202 for performing the decompression. The processor may then access the decompressed data and store it in the CPU cache. If the decompressed data is evicted from the CPU cache, the decompressed data may be regenerated from the compressed data by decompressor 200. For example, FIG. 12 shows a virtual decompression cache 220 within the cacheable address space 30 of the system 10. The virtual decompression cache 220 is assigned an address range within the cacheable address space 30, and the memory 16 may be assigned a separate address range. The CPU cache 32 is also shown, and is illustrated storing blocks from both the memory 16 and the virtual decompression cache 220. The decompression buffer 208 is shown storing the block C from the virtual decompression cache 220 but not storing the block D from the virtual decompression cache 220. If block D is evicted from the CPU cache 32, block D may be regenerated from the corresponding compressed data.

Generally, the control circuit 204 may employ embodiments similar to those shown in FIGS. 3-8 to control the operation the virtual decompression cache 220. The decompression cache directory 206 may map compressed data to corresponding decompressed data in the virtual decompression cache 220. The decompression buffer 208 may store decompressed data similar to the code buffer 26. The configuration registers 210 may define the address range of the virtual decompression cache 220, or the address range may be predetermined.

As FIGS. 11-12 illustrate, the virtual caching mechanism described herein is not limited to instruction translation, but may be used in other contexts as well. Generally, the virtual caching mechanism may be particularly useful with any type of regenerable data. Generally, the virtual caching mechanism may monitor for addresses from the CPU 12 which are within the address range assigned to the virtual cache, and may cause a generation of the requested data from the source data. The virtual caching mechanism may cause the generation of a block of data either directly (e.g. activating circuitry which generates the block of data) or indirectly (e.g. causing the execution of a code sequence in the CPU 12 which activates the circuitry or performs the generation). As used herein, the term “regenerable data” refers to data (which may include instruction code or operand data) which may be generated by applying a predetermined transformation on source data. The term “source data” as used herein refers to data (which may including instruction code or operand data) from which the regenerable data is generated. The term “directory” as used herein refers to a memory which maps a first set of addresses to a second set of addresses. The term “block of data” or “data block” generally refers to a contiguous set of data bytes (again, data may include instruction code or operand data), wherein the number of bytes is equal to the number of bytes of data stored in one cache storage location of the cache. The block may be of any suitable size (e.g. 16 bytes, 32 bytes, 64 bytes, 128 bytes, etc.)

It is noted that other embodiments may not include the decompression engine 202 and may perform the decompression in software but may still use the virtual decompression cache 220 to limit the amount of the memory 16 occupied by decompressed data.

Carrier Medium

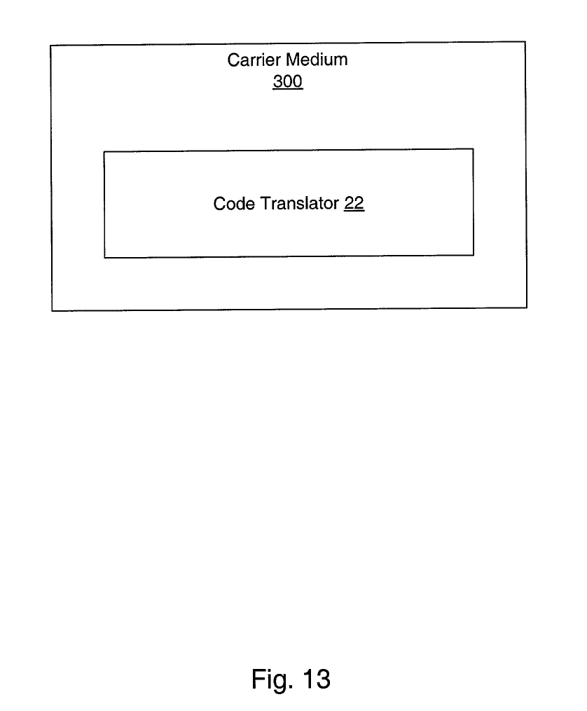

Turning next to FIG. 13, a block diagram of a carrier medium 300 including a database representative of the code translator 22 is shown. Generally speaking, a carrier medium may include storage media such as magnetic or optical media, e.g., disk or CD-ROM, volatile or non-volatile memory media such as RAM (e.g. SDRAM, RDRAM, SRAM, etc.), ROM, etc., as well as transmission media or signals such as electrical, electromagnetic, or digital signals, conveyed via a communication medium such as a network and/or a wireless link.

Generally, the database of the code translator 22 carried on the carrier medium 300 may be a database which can be read by a program and used, directly or indirectly, to fabricate the hardware comprising the code translator 22. For example, the database may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates in a synthesis library. The netlist comprises a set of gates and interconnect therebetween which also represent the functionality of the hardware comprising the code translator 22. The netlist may then be placed and routed to produce a data set describing geometric shapes to be applied to masks. The data set, for example, may be a GDSII (General Design System, second revision) data set. The masks may then be used in various semiconductor fabrication steps to produce a semiconductor circuit or circuits corresponding to the code translator 22. Alternatively, the database on the carrier medium 300 may be the netlist (with or without the synthesis library) or the data set, as desired.

While the carrier medium 300 carries a representation of the code translator 22, other embodiments may carry a representation of any portion of the code translator 22, as desired, including any combination of a control circuit for virtual translation caching, a translation cache directory, a code buffer, configuration registers, a translation engine, etc. Furthermore, the carrier medium 300 may carry a representation of any embodiment of the system 10 or any portion thereof. Still further, the carrier medium may carry a representation of the decompressor 200 or any portion thereon including any combination of a control circuit for virtual decompression caching, a decompression cache directory, a decompression buffer, configuration registers, a decompression engine, etc.

Numerous variations and modifications will become apparent to those skilled in the art once the above disclosure is fully appreciated. It is intended that the following claims be interpreted to embrace all such variations and modifications.

What is claimed is:

1. An apparatus comprising:
a buffer configured to store at least one block of data; and
a control circuit coupled to the buffer and to receive a first address transmitted by a central processing unit (CPU), wherein the first address identifies a corresponding block of data, and wherein the control circuit is configured to detect whether or not the first address is in a first address range, and wherein, if the corresponding block of data is stored in the buffer, the control circuit is configured to provide the corresponding block of data to the CPU, and wherein, if the corresponding block if data is not stored in the buffer and the first address is in the first address range, the control circuit is configured to cause a generation of the corresponding block of data from a source data.

2. The apparatus as recited in claim 1 further comprising a directory configured to store a mapping of addresses within a second address range corresponding to the source data to addresses in the first address range, and wherein the control circuit is configured to read a second address within the second address range from the directory in order to cause the generation of the corresponding block of data, the second address being mapped to the first address in the directory.

3. The apparatus as recited in claim 2 wherein the control circuit is configured to cause the generation of the corresponding block of data by providing at least a portion of a code sequence to the CPU instead of the corresponding block of data, wherein the code sequence, when executed, initiates the generation.

4. The apparatus as recited in claim 2 further comprising a second circuit coupled to the control circuit, wherein the second circuit is configured to generate the corresponding block of data from the source data, and wherein the control circuit is configured to cause the generation by providing the second address to the second circuit.

5. The apparatus as recited in claim 4 wherein the control circuit is further configured to provide the corresponding block of data to the CPU subsequent to the generation of the corresponding block of data by the second circuit.

6. The apparatus as recited in claim 1 wherein the control circuit is configured to store the corresponding block of data in the buffer subsequent to the generation of the corresponding block of data.

7. The apparatus as recited in claim 1 wherein the source data is a first code sequence coded in a first instruction set, and wherein the corresponding block of data is included in a second code sequence coded in a second instruction set, and wherein the generation comprises translating the first code sequence to produce the second code sequence.

8. The apparatus as recited in claim 1 wherein the source data is compressed data, and wherein the corresponding block of data is uncompressed data, and wherein the generation comprises decompressing the first compressed data to produce the uncompressed data.

9. A carrier medium storing a database representing an apparatus, the apparatus comprising:
a buffer configured to store at least one block of data; and
a control circuit coupled to the buffer and to receive a first address transmitted by a central processing unit (CPU), wherein the first address identifies a corresponding block of data, and wherein the control circuit is configured to detect whether or not the first address is in a first address range, and wherein, if the corresponding block of data is stored in the buffer, the control circuit is configured to provide the corresponding block of data to the CPU, and wherein, if the corresponding block if data is not stored in the buffer and the first address is in the first address range, the control circuit is configured to cause a generation of the corresponding block of data from a source data.

10. The carrier medium as recited in claim 9 wherein the apparatus further comprises a directory configured to store a mapping of addresses within a second address range corresponding to the source data to addresses in the first address range, and wherein the control circuit is configured to read a second address within the second address range from the directory in order to cause the generation of the corresponding block of data, the second address being mapped to the first address in the directory.

11. The carrier medium as recited in claim 10 wherein the control circuit is configured to cause the generation of the corresponding block of data by providing at least a portion of a code sequence to the CPU instead of the corresponding block of data, wherein the code sequence, when executed, initiates the generation.

12. The carrier medium as recited in claim 10 wherein the apparatus further comprises a second circuit coupled to the control circuit, wherein the second circuit is configured to generate the corresponding block of data from the source data, and wherein the control circuit is configured to cause the generation by providing the second address to the second circuit.

13. The carrier medium as recited in claim 12 wherein the control circuit is further configured to provide the corresponding block of data to the CPU subsequent to the generation of the corresponding block of data by the second circuit.

14. The carrier medium as recited in claim 9 wherein the control circuit is configured to store the corresponding block of data in the buffer subsequent to the generation of the corresponding block of data.

15. The carrier medium as recited in claim 9 wherein the source data is a first code sequence coded in a first instruction set, and wherein the corresponding block of data is included in a second code sequence coded in a second instruction set, and wherein the generation comprises translating the first code sequence to produce the second code sequence.

16. The carrier medium as recited in claim 9 wherein the source data is compressed data, and wherein the corresponding block of data is uncompressed data, and wherein the generation comprises decompressing the first compressed data to produce the uncompressed data.

17. A system comprising:
a central processing unit (CPU);
a cache configured to store blocks of data for use by the CPU; and
a circuit coupled to receive a first address transmitted by the CPU, wherein the first address identifies a corresponding block of data generated from a source data if the first address is within a first address range detected by the circuit, and wherein the circuit is configured to generate the corresponding block of data from the source data if the corresponding block of data is not available;
and wherein the cache is coupled to receive the corresponding block of data from the circuit and is configured to store the corresponding block of data.

18. The system as recited in claim 17 wherein the circuit comprises a buffer configured to store at least one block of data, and wherein the corresponding block of data is not available if the corresponding block of data is not stored in the buffer.

19. The system as recited in claim 18 wherein the circuit is configured to store the corresponding block of data in the buffer subsequent to generating the corresponding block of data.

20. The system as recited in claim 19 wherein the circuit is coupled to receive a second address transmitted by the CPU, wherein the second address identifies a second corresponding block of data generated from the source data if the second address is within the first address range, and wherein the circuit is configured to generate the second corresponding block of data from the source data if the second corresponding block of data is not stored in the buffer, and wherein the circuit is configured to overwrite the corresponding block of data with the second corresponding block of data, and wherein the corresponding block of data is not invalidated in the cache in response to overwriting the corresponding block of data.

21. The system as recited in claim 17 further comprising a memory coupled to the CPU, wherein the memory is addressed via a second address range separate from the first address range, and wherein the cache is configured to store data read from the memory.

22. The system as recited in claim 21 wherein the corresponding block of data is not stored in the memory.

23. The system as recited in claim 21 wherein the source data is data stored in the memory.

24. The system as recited in claim 17 wherein the cache is integrated into the CPU.

25. The system as recited in claim 17 wherein the circuit is a code translator configured to generate a second code sequence coded in a second instruction set from a first code sequence coded in a first instruction set, and wherein the second code sequence includes the corresponding block of data, and wherein the source data is the first code sequence.

26. The system as recited in claim 17 wherein the circuit is a decompressor and wherein the source data is compressed data and decompressed data corresponding to the compressed data includes the corresponding block of data.

27. A method comprising:
detecting that a first address is within a first address range, the first address identifying a corresponding block of data which is generated from a source data;
causing a generation of the corresponding block of data if the corresponding block of data is not available; and
caching the corresponding block of data in a cache which stores blocks of data for use by a central processing unit (CPU), and wherein the corresponding block of data is not also stored in a main memory system.

28. The method as recited in claim 27 further comprising storing the corresponding block of data in a buffer, and wherein the corresponding block of data is not available if the corresponding block of data is not stored in the buffer.

29. The method as recited in claim 28 further comprising
detecting that a second address is within the first address range, the second address identifying a second corresponding block of data which is generated from the source data;
generating the second corresponding block of data;
storing the second corresponding block of data in the buffer, the storing overwriting the corresponding block of data in the buffer, wherein the corresponding block of data is not invalidated in the cache in response to the storing overwriting the corresponding block of data in the buffer; and
caching the second corresponding block of data in the cache.

30. The method as recited in claim 27 wherein the generation comprises translation, and wherein the source data is a first code sequence coded in a first instruction set, and wherein the corresponding block of data is included in a second code sequenced coded in a second instruction set, the second code sequence being the translation of the first code sequence.

31. The method as recited in claim 27 wherein the generation comprises decompression, and wherein the source data is compressed data, and wherein the corresponding block of data is included in decompressed data corresponding to the compressed data.
